(19) United States
(12) Patent Application Publication
(10) Pub. No.: US 2010/0283677 A1
(43) Pub. Date: Nov. 11, 2010

(54) Method, system, user equipment, network element and software product for generic broadcasted positioning assistance data

(75) Inventor: Ismo Halivaara, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation, Espoo (FI)

(21) Appl. No.: 12/008,703

(22) Filed: Jan. 10, 2008

Related U.S. Application Data
(60) Provisional application No. 60/879,910, filed on Jan. 10, 2007.

(51) Int. Cl. G01S 19/12

(52) U.S. Cl. 342/357.49

(57) ABSTRACT

A method, system, user equipment and network element are for creating positioning assistance data messages in a generic format that assist mobile stations to determine their positions based upon signals from various types of global navigation satellite system. Scheduling information is broadcasted from a terrestrial base station, describing which of the positioning assistance data messages contain positioning assistance data for which of the types of global navigation satellite system. That positioning assistance data is broadcasted in messages from a terrestrial base station, according to the scheduling information.

### CROSS-REFERENCE TO RELATED APPLICATION

Priority is claimed to U.S. Provisional Application No. 60/879,910 filed on Jan. 10, 2007.

### FIELD OF THE INVENTION

The invention relates to wireless telecommunications, and more particularly to satellite-based positioning and navigation systems.

### BACKGROUND OF THE INVENTION

There are currently two public global positioning system (GPS) systems. The NAVSTAR (Navigation Signal Timing and Ranging) system is owned by the United States and is managed by the Department of Defense. The GLONASS (Global Orbiting Navigation Satellite System) system is owned by the Russian Federation. While both NAVSTAR and GLONASS systems are global positioning systems, the NAVSTAR system is often referred to as the GPS because it was generally available first. Nevertheless, both systems are GPS systems and the reader should keep this in mind. In the future, there will be moreover a European system called Galileo.

In the case of NAVSTAR, for example, there are more than 20 satellites, also referred to as space vehicles (SV), that orbit the earth. Each of the satellites transmits two carrier signals L1 and L2. One of these carrier signals L1 is employed for carrying a navigation message and code signals of a standard positioning service (SPS). The L1 carrier phase is modulated by each satellite with a different C/A (Coarse Acquisition) code. Thus, different channels are obtained for the transmission by the different satellites. The C/A code is a pseudo random noise (PRN) code, which is spreading the spectrum over a nominal bandwidth of 2.046 MHz It is repeated every 1023 bits, the epoch of the code being 1 ms. The bits of the C/A code are also referred to as chips. The carrier frequency of the L1 signal is further modulated with the navigation information at a bit rate of 50 bit/s. The navigation information comprises in particular a timestamp indicating the time of transmission and ephemeris and almanac parameters.

In addition to GPS systems, there are also satellite-based augmentation systems (SBAS) that will provide additional information, for example so that GPS can improve positioning performance and integrity. SBAS satellites are typically geostationary satellites serving only a certain geographical region, thus not being globally available. Therefore, there are several SBASs either deployed or being under development to cover various areas such as Wide Area Augmentation System (WAAS) for North-America and Pacific areas, European Geostationary Navigation Overlay System (EGNOS) for European and North-Africa areas, and Multi-functional Satellite Augmentation System (MSAS) for Asian area. SBAS satellites may use the same signal structures as GPS to enable the reception and demodulation of the SBAS signals with the same GPS receiver hardware, so that only changes in the GPS receiver software would be needed.

GNSS stands for Global Navigation Satellite System. The term GNSS is used to refer collectively to GPS, Galileo, GLONASS, SBAS, LAAS and QZSS (Quasi-Zenith Satellite System), or an element thereof. A receiver supporting GNSSs will typically use either or both NAVSTAR and GLONASS to provide positioning, along with other components to improve accuracy and provide fast warning of problems.

The present invention relates to the field of Assisted GNSS, such as A-Galileo and other GNSS that will be supported in the future. Assisted GPS (Global Positioning System), or A-GPS, uses an assistance server to cut down the time needed by a ranging receiver (GPS receiver) to determine a location using GPS. It is useful in urban areas, where a user is often located in “urban canyons,” and when a user is under heavy tree cover. It is becoming more common and is often associated with Location Based Services (LBS) provided over cellular networks.

A-GPS differs from (ordinary) GPS by including the assistance server. In (ordinary) GPS networks there are only GPS satellites and GPS receivers. In A-GPS networks, the receiver, being limited in processing power and normally under less than ideal locations for position fixing, communicates with the assistance server, which has high processing power and access to a reference network. The A-GPS receiver and the assistance server share tasks, reducing the computational burden on the GPS receiver, but with the requirement of performing cellular communication with the assistance server.

An A-GPS receiver (i.e. one configured to use A-GPS and so communicate with an assistance server over a cellular network), can ask an assistance server, located at what is often called a (serving) Mobile Location Center, for the latest ephemeris for a satellite, or for corrections to the ephemeris to allow for a more accurate position fix determination by the A-GPS receiver.

There are currently no adequate methods and systems for broadcasting of generic assistance data in A-GNSS. Solving this problem is the focus of the present invention.

Some of the current work in the Third Generation Partnership Project (3GPP) standardization forums is now focusing on near-future GNSSs, including European Galileo, Russian GLONASS, SBASs and Japanese QZSS, to define assistance data messages and features based on these systems. These systems will be deployed (or re-deployed in the GLONASS case) in coming years. Naturally, the assistance data and assistance requesting messages need also to be redefined to be compatible with these coming systems. Some of the current proposals include also a Differential GNSS (DGNSS) that will extend the differential corrections from GPS to other satellite systems and to modernized GPS.

In every cellular system, a base station (BS) broadcasts information about the system parameters. This information is transmitted on a broadcast channel which can be received by every mobile station located within the coverage area of that base station. Typically in cellular standards, broadcast messages are defined that carry assistance data for certain positioning methods, e.g. A-GPS.

For example, consider one of the systems within the third generation of mobile communications: the Universal Mobile Telecommunications System (UMTS) which delivers voice, data, multimedia, and wideband information to stationary as well as mobile customers. UMTS is designed to accommodate high system capacity and data capability. The UMTS architecture includes the UMTS Terrestrial Radio Access Network (UTRAN).

In 3GPP UTRAN, the broadcast function and messages to carry assistance data for various positioning methods are defined in 3GPP TS 25.331 V7.3.0 (2006-12), “Protocol Specification, Release 7”, which is incorporated by reference in its entirety herein. In this system, the information is transmitted in System Information Blocks (SIB). Currently about two dozen SIBs have been defined for different purposes. As not all of these blocks are needed by every mobile station (MS), the BS also transmits scheduling blocks that tell the timing of a certain SIB so that a MS can switch on its receiver only when relevant data is broadcasted.

A generic (i.e. independent of any specific GNSS) A-GNSS message structure has been agreed in 3GPP for dedicated (one transmitter to one receiver) positioning assistance data delivery. See GP-062407, 3GPP TS 44.031 V7.3.0 (2006-12), “Mobile Station (MS)-Serving Mobile Location Centre (SMLC) Radio Resource LCS Protocol (RRLP) Release 7” and also see the international patent application titled “Supporting an Assisted Satellite Based Positioning” (WO2006134412 filed Jun. 13, 2005), both of which are herein incorporated by reference in their entirety. For implementation simplicity and efficiency it would be beneficial to use the same sort of messaging structure also for data broadcasts (one transmitter to many receivers). The problem with this approach is that as messages are not dedicated to any GNSS, the mobile station that supports for instance Galileo GNSS would have to receive and check each message to find out whether that message contains Galileo specific data or data for some other GNSS. This would lead to increased MS power consumption as the MS would have to turn its RF part on to receive unnecessary data. This problem could be overcome by defining separate messages for each GNSS, but this would lead to another problem: increased complexity in specification structure and product implementation.

This problem has not been addressed before, partly because the generic message concept in cellular information broadcasting is new. In order to avoid unnecessary data reception, the cellular specifications have used fixed messages with either fixed scheduling or flexible scheduling that is communicated with scheduling messages.

### SUMMARY OF THE INVENTION

The present invention discloses a novel method for broadcasting assistance data from network to mobile stations in a generic format. In this method, a generic message is used for broadcasting GNSS-specific data. Because the message is generic, it can be used to carry assistance data for any GNSS.

The information about which broadcasted message contains data for which GNSS is included in the scheduling information. This allows the use of a generic concept in broadcasted messages without the reception overhead of unnecessary data. In addition, the data that is common to all GNSS may be separated from GNSS-specific data and broadcasted in a separate information block.

### BRIEF DESCRIPTION OF THE DRAWINGS

FIG. 1 is a flow chart showing a method according to an embodiment of the present invention.

FIG. 2 is a block diagram showing an embodiment of a system according to the present invention.

### DETAILED DESCRIPTION OF THE INVENTION

A preferred embodiment of the present invention will now be described, merely to illustrate one way of implementing the invention, and without limiting the scope or coverage of what is described elsewhere in this application.

This embodiment involves communication between a base station and mobile stations, and therefore the main part of implementation involves changes in software. In a preferred implementation, the generic message is copied from the point-to-point signaling. Software changes would be made mainly to the scheduling information. This would maximize the implementation efficiency and forward compatibility.

This invention is primarily for the interface between the base station and mobile station. However, it also affects the interface within the network from a Serving Mobile Location Center (SMLC) to a base station (BS), because these positioning assistance data messages are created in the SMLC for routing to the base station (e.g. via other network elements), to be broadcasted by the base station.

Following the fixed-message scheme currently used, every time when support for a new GNSS is added then new messages would be needed. For each GNSS this would mean four to five new messages. In addition to Galileo, there are several other systems that are possible candidates to be added in the future, such as Glonass, GPS modernization, and QZSS. Having new messages for each of these could mean doubling the current number of SIBS in TS 25.331. However, with this invention, when support for new GNSS is added, only new scheduling needs to be taken into account, because the assistance data message remains the same.

Several of the concepts covered by the present invention will now be briefly listed, without in any way limiting what will ultimately be claimed in a regular patent application claiming priority hereto.

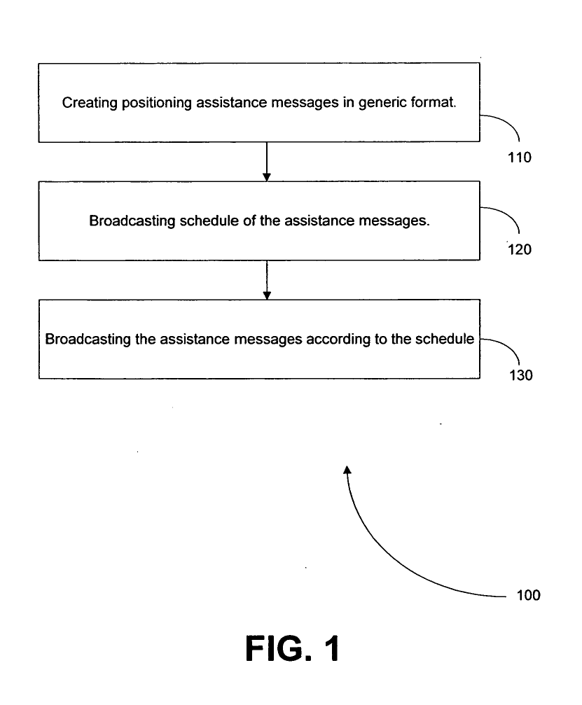

FIG. 1 is a flow chart showing a basic method according to an embodiment of the invention. The present invention includes a first concept that is a method 100 comprising: creating 110 a plurality of positioning assistance data messages in a generic format that assist a plurality of mobile stations determine their positions based upon signals from a plurality of types of global navigation satellite system; broadcasting 120 scheduling information from a terrestrial base station describing which of the positioning assistance data messages contain or contains positioning assistance data for which of the types of global navigation satellite system; and broadcasting 130 said positioning assistance data messages from said or another terrestrial base station, according to the scheduling information.

The present invention includes a second concept that is the first concept further comprising broadcasting in a separate information block, or in a separate at least one of the positioning assistance data messages having a generic format, common positioning assistance data that is common to more than one of said types of global navigation satellite system.

The present invention includes a third concept that is the second concept, wherein the common positioning assistance data is common to all of said types of global navigation satellite system that correspond to said plurality of positioning assistance data messages.

The present invention includes a fourth concept that is the first concept, wherein the types of global navigation satellite system include at least two that share a satellite in common.

The present invention include a fifth concept that is the first concept, wherein said generic format is substantially identical to a message structure used for dedicated positioning assistance data delivery.

The present invention include a sixth concept that is a software product, the software product comprising a computer readable medium having executable codes embedded therein; the codes, when executed, adapted to carry out the functions of: creating a plurality of positioning assistance data messages in a generic format that assist a plurality of mobile stations determine their positions based upon signals from a plurality of types of global navigation satellite system; broadcasting scheduling information from a terrestrial base station describing which of the positioning assistance data messages contain or contains positioning assistance data for which of the types of global navigation satellite system; and broadcasting said positioning assistance data messages from said or another terrestrial base station, according to the scheduling information.

The present invention includes a seventh concept that is the sixth said functions also comprise broadcasting in a separate information block, or in a separate at least one of the positioning assistance data messages having a generic format, common positioning assistance data that is common to more than one of said types of global navigation satellite system.

The present invention includes an eighth concept that is the seventh concept, wherein the common positioning assistance data is common to all of said types of global navigation satellite system that correspond to said plurality of positioning assistance data messages.

The present invention includes a ninth concept that is the sixth concept, wherein the types of global navigation satellite system include at least two that share a satellite in common.

The present invention include a tenth concept that is the sixth concept, wherein said generic format is substantially identical to a message structure used for dedicated positioning assistance data delivery.

The present invention includes an eleventh concept that is system or apparatus or network element comprising: means for creating a plurality of positioning assistance data messages in a generic format that assist a plurality of mobile stations determine their positions based upon signals from a plurality of types of global navigation satellite system; means for broadcasting scheduling information from a terrestrial base station describing which of the positioning assistance data messages contain or contains positioning assistance data for which of the types of global navigation satellite system; and means for broadcasting said positioning assistance data messages from said or another terrestrial base station, according to the scheduling information.

The present invention includes a twelfth concept that is the eleventh concept further comprising means for broadcasting in a separate information block, or in a separate at least one of the positioning assistance data messages having a generic format, common positioning assistance data that is common to more than one of said types of global navigation satellite system.

The present invention includes a thirteenth concept that is the twelfth concept, wherein the common positioning assistance data is common to all of said types of global navigation satellite system that correspond to said plurality of positioning assistance data messages.

The present invention includes a fourteenth concept that is the eleventh concept, wherein the types of global navigation satellite system include at least two that share a satellite in common.

The present invention include a fifteenth concept that is the eleventh concept, wherein said generic format is substantially identical to a message structure used for dedicated positioning assistance data delivery.

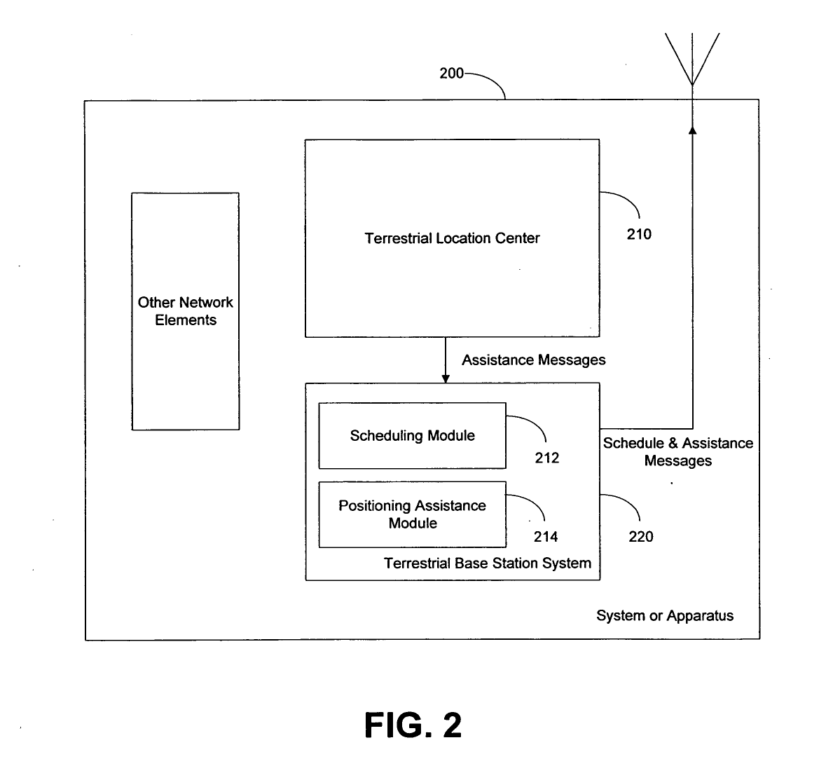

FIG. 2 is a block diagram showing basic network elements according to an embodiment of the invention. The present invention includes a sixteenth concept that is system or apparatus or network element 200 comprising: a location center 210 configured to create a plurality of positioning assistance data messages in a generic format that assist a plurality of mobile stations determine their positions based upon signals from a plurality of types of global navigation satellite system; a scheduling module 212 configured to broadcast scheduling information from a terrestrial base station 220 describing which of the positioning assistance data messages contain or contains positioning assistance data for which of the types of global navigation satellite system; and a positioning assistance module 214 configured to broadcast said positioning assistance data messages from said or another terrestrial base station, according to the scheduling information.

The present invention includes a seventeenth concept that is the sixteenth concept further comprising a common data module configured to broadcast in a separate information block, or in a separate at least one of the positioning assistance data messages having a generic format, common positioning assistance data that is common to more than one of said types of global navigation satellite system.

The present invention includes an eighteenth concept that is the seventeenth concept, wherein the common positioning assistance data is common to all of said types of global navigation satellite system that correspond to said plurality of positioning assistance data messages.

The present invention includes a nineteenth concept that is the sixteenth concept, wherein the types of global navigation satellite system include at least two that share a satellite in common.

The present invention includes a twentieth concept that is the sixteenth concept, wherein said generic format is substantially identical to a message structure used for dedicated positioning assistance data delivery.

The present invention includes a twenty-first concept that is mobile station comprising: a receiver configured to receive at least one of a plurality of broadcasted positioning assistance data messages in a generic format that assist in determining position based upon signals from at least one of a plurality of types of global navigation satellite system; a schedule reading module configured to read broadcasted scheduling information from a terrestrial base station describing which of the positioning assistance data messages contain or contains positioning assistance data for which of the types of global navigation satellite system; and a positioning module configured to use said positioning assistance data messages from said or another terrestrial base station according to the scheduling information.

The present invention includes a twenty-second concept that is the twenty-first concept further comprising a common data processing module configured to process common data broadcasted in a separate information block, or in a separate at least one of the positioning assistance data messages having a generic format, said common data being common to more than one of said types of global navigation satellite system.

The embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes the CPU processor shown, comprising a single processing unit, multiple processing units capable of parallel operation, or the CPU can be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, similar to CPU, memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, network element, user equipment, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
creating a plurality of positioning assistance data messages in a generic format that assist a plurality of mobile stations determine their positions based upon signals from a plurality of types of global navigation satellite system;
broadcasting scheduling information from a terrestrial base station describing which of the positioning assistance data messages contain or contains positioning assistance data for which of the types of global navigation satellite system; and
broadcasting said positioning assistance data messages from said or another terrestrial base station, according to the scheduling information.

2. The method of claim 1, further comprising broadcasting in a separate information block, or in a separate at least one of the positioning assistance data messages having a generic format, common positioning assistance data that is common to more than one of said types of global navigation satellite system.

3. The method of claim 2, wherein the common positioning assistance data is common to all of said types of global navigation satellite system that correspond to said plurality of positioning assistance data messages.

4. The method of claim 1, wherein the types of global navigation satellite system include at least two that share a satellite in common.

5. The method of claim 1, wherein said generic format is substantially identical to a message structure used for dedicated positioning assistance data delivery.

6. A software product comprising a computer readable medium having executable codes embedded therein; the codes, when executed, adapted to carry out the functions of:
creating a plurality of positioning assistance data messages in a generic format that assist a plurality of mobile stations determine their positions based upon signals from a plurality of types of global navigation satellite system;
broadcasting scheduling information from a terrestrial base station describing which of the positioning assistance data messages contain or contains positioning assistance data for which of the types of global navigation satellite system; and
broadcasting said positioning assistance data messages from said or another terrestrial base station, according to the scheduling information.

7. The software product of claim 6, wherein said functions also comprise broadcasting in a separate information block, or in a separate at least one of the positioning assistance data messages having a generic format, common positioning assistance data that is common to more than one of said types of global navigation satellite system.

8. The software product of claim 7, wherein the common positioning assistance data is common to all of said types of global navigation satellite system that correspond to said plurality of positioning assistance data messages.

9. The software product of claim 6, wherein the types of global navigation satellite system include at least two that share a satellite in common.

10. The software product of claim 6, wherein said generic format is substantially identical to a message structure used for dedicated positioning assistance data delivery.

11. An apparatus comprising:
means for creating a plurality of positioning assistance data messages in a generic format that assist a plurality of mobile stations determine their positions based upon signals from a plurality of types of global navigation satellite system;
means for broadcasting scheduling information from a terrestrial base station describing which of the positioning assistance data messages contain or contains positioning assistance data for which of the types of global navigation satellite system; and
means for broadcasting said positioning assistance data messages from said or another terrestrial base station, according to the scheduling information.

12. The apparatus of claim 11, further comprising means for broadcasting in a separate information block, or in a separate at least one of the positioning assistance data messages having a generic format, common positioning assistance data that is common to more than one of said types of global navigation satellite system.

13. The apparatus of claim 12, wherein the common positioning assistance data is common to all of said types of global navigation satellite system that correspond to said plurality of positioning assistance data messages.

14. The apparatus of claim 11, wherein the types of global navigation satellite system include at least two that share a satellite in common.

15. The apparatus of claim 11, wherein said generic format is substantially identical to a message structure used for dedicated positioning assistance data delivery.

16. An apparatus comprising:
a location center configured to create a plurality of positioning assistance data messages in a generic format that assist a plurality of mobile stations determine their positions based upon signals from a plurality of types of global navigation satellite system;
a scheduling module configured to broadcast scheduling information from a terrestrial base station describing which of the positioning assistance data messages contain or contains positioning assistance data for which of the types of global navigation satellite system; and
a positioning assistance module configured to broadcast said positioning assistance data messages from said or another terrestrial base station, according to the scheduling information.

17. The apparatus of claim 16, further comprising a data module configured to broadcast in a separate information block, or in a separate at least one of the positioning assistance data messages having a generic format, common positioning assistance data that is common to more than one of said types of global navigation satellite system.

18. The apparatus of claim 17, wherein the common positioning assistance data is common to all of said types of global navigation satellite system that correspond to said plurality of positioning assistance data messages.

19. The apparatus of claim 16, wherein the types of global navigation satellite system include at least two that share a satellite in common.

20. The apparatus of claim 16, wherein said generic format is substantially identical to a message structure used for dedicated positioning assistance data delivery.

21. A mobile station comprising:
a receiver configured to receive at least one of a plurality of broadcasted positioning assistance data messages in a generic format that assist in determining position based upon signals from at least one of a plurality of types of global navigation satellite system;
a schedule reading module configured to read broadcasted scheduling information from a terrestrial base station describing which of the positioning assistance data messages contain or contains positioning assistance data for which of the types of global navigation satellite system; and
a positioning module configured to use said positioning assistance data messages from said or another terrestrial base station according to the scheduling information.

22. The mobile station of claim 21, further comprising a data processing module configured to process common data broadcasted in a separate information block, or in a separate at least one of the positioning assistance data messages having a generic format, said common data being common to more than one of said types of global navigation satellite system.

23. An system comprising:
a location center configured to create a plurality of positioning assistance data messages in a generic format that assist a plurality of mobile stations determine their positions based upon signals from a plurality of types of global navigation satellite system;
a scheduling module configured to broadcast scheduling information from a terrestrial base station describing which of the positioning assistance data messages contain or contains positioning assistance data for which of the types of global navigation satellite system; and
a positioning assistance module configured to broadcast said positioning assistance data messages from said or another terrestrial base station, according to the scheduling information.

24. The system of claim 23, further comprising a data module configured to broadcast in a separate information block, or in a separate at least one of the positioning assistance data messages having a generic format, common positioning assistance data that is common to more than one of said types of global navigation satellite system.

25. The system of claim 24, wherein the common positioning assistance data is common to all of said types of global navigation satellite system that correspond to said plurality of positioning assistance data messages.
